(19) United States
(12) Patent Application Publication
(10) Pub. No.: US 2026/0111993 A1
(43) Pub. Date: Apr. 23, 2026

(54) IMAGE PROCESSING METHOD AND APPARATUS, AND TERMINAL DEVICE

(71) Applicant: Beijing Zitiao Network Technology Co., Ltd., Beijing (CN)

(72) Inventor: Dou YIN, Beijing (CN)

(21) Appl. No.: 19/367,571

(22) Filed: Oct. 23, 2025

(30) Foreign Application Priority Data
Oct. 23, 2024 (CN) 202411487532.2

(51) Int. Cl. G06T 1/20

(52) U.S. Cl. CPC G06T 1/20

(57) ABSTRACT

The present disclosure provides an image processing method and apparatus, and a terminal device. The method includes: in response to post-processing for a first image, determining a first rendering texture based on the post-processing and a texture pool used for storing a plurality of rendering textures required by the post-processing; copying the first image to the first rendering texture, to obtain a second rendering texture; and performing the post-processing on the second rendering texture, and storing the first rendering texture or the second rendering texture in the texture pool.

### CROSS-REFERENCE TO RELATED APPLICATION(S)

The present disclosure claims the priority from the CN patent application No. 202411487532.2 entitled “Image processing method and apparatus, and terminal device” filed with the China National Intellectual Property Administration (CNIPA) on Oct. 23, 2024, the contents of which are hereby incorporated by reference in their entirety.

### FIELD

The present disclosure relates to the technical field of image processing, in particular, to an image processing method and apparatus, and a terminal device.

### BACKGROUND

Post-processing images refer to fine-tuning and optimizing generated images, including, for example, adding filters to images, whitening images, and the like.

### SUMMARY

The embodiments of the present disclosure provide an image processing method and apparatus, and a terminal device.

In a first aspect, the embodiments of the present disclosure provide an image processing method, comprising:
in response to post-processing for a first image, determining a first rendering texture based on the post-processing and a texture pool used for storing a plurality of rendering textures required by the post-processing;
copying the first image to the first rendering texture, to obtain a second rendering texture; and
performing the post-processing on the second rendering texture, and storing the first rendering texture or the second rendering texture in the texture pool.

In a second aspect, the embodiments of the present disclosure provide an image processing apparatus, comprising a determining module, a copying module, a processing module, and a storage module, wherein:
the determining module is configured to, in response to post-processing for a first image, determine a first rendering texture based on the post-processing and a texture pool used for storing a plurality of rendering textures required by the post-processing;
the copying module is configured to copy the first image to the first rendering texture, to obtain a second rendering texture;
the processing module is configured to perform the post-processing on the second rendering texture; and
the storage module is configured to store the first rendering texture or the second rendering texture in the texture pool.

In a third aspect, the present disclosure provides a terminal device comprising: a processor and a memory, wherein:
the memory stores computer executable instructions; and
the processor executes the computer executable instructions stored in the memory, to cause the processor to perform the image processing method in the first aspect and various image processing methods possibly involved in the first aspect.

In a fourth aspect, the present disclosure provides a computer-readable storage medium, wherein the computer-readable storage medium stores therein computer-executable instructions, and the processor, when executing the computer-executable instructions, performs the image processing method in the first aspect and various image processing methods possibly involved in the first aspect.

In a fifth aspect, the present disclosure provides a computer program product comprising a computer program that, when executed by a processor, implements the image processing method in the first aspect and various image processing methods possibly involved in the first aspect.

### BRIEF DESCRIPTION OF THE DRAWINGS

In order to make clearer the technical solution according to the embodiments of the present disclosure or the prior art, brief introduction of the drawings required in the embodiments or the prior art will be provided below. Apparently, the drawings described below are only a part of the embodiments according to the present disclosure, and the ordinary skill in the art could derive other drawings on the basis of these drawings, without doing creative work.

FIG. 1 is a schematic diagram of an application scenario provided by embodiments of the present disclosure;

FIG. 2 is a schematic flowchart of an image processing method provided by embodiments of the present disclosure;

FIG. 3 is a schematic diagram of a process of determining post-processing for a first image provided by embodiments of the present disclosure;

FIG. 4 is a schematic diagram of a texture mechanism provided by embodiments of the present disclosure;

FIG. 5 is a schematic diagram of a method of determining a second rendering texture provided by embodiments of the present disclosure;

FIG. 6 is a schematic diagram of a further method of determining a second rendering texture provided by embodiments of the present disclosure;

FIG. 7 is a schematic diagram of a method of determining a first rendering texture provided by embodiments of the present disclosure;

FIG. 8 is a schematic diagram of a method of releasing a rendering texture provided by embodiments of the present disclosure;

FIG. 9 is a schematic diagram of a structure of an image processing apparatus provided by embodiments of the present disclosure; and

FIG. 10 is a schematic diagram of a structure of a terminal device provided by embodiments of the present disclosure.

### DETAILED DESCRIPTION OF EMBODIMENTS

Herein, detailed description will be made to example embodiments, wherein examples thereof are shown in the drawings. In the following description of the drawings, the same symbols in different drawings represent the same or similar elements unless otherwise indicated. The implementations set forth in the following description of the example embodiments do not represent all the implementations consistent with the present disclosure. Instead, they are merely examples of apparatuses and methods consistent with some aspects of the present disclosure.

Prior to applying the technical solution according to various embodiments of the present disclosure, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers or storage media that perform operations of the technical solution of the present disclosure.

As an optional implementation, without limitation, in response to receiving an active request from a user, the method of sending prompt information to the user may, for example, include a pop-up window, wherein the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

For ease of understanding, concepts involved in the embodiments of the present disclosure will be explained below.

A terminal device is a device with a wireless transceiver function. The terminal device can be deployed indoors or outdoors, or can be handheld, wearable, or vehicle-mounted. The terminal device may be a mobile phone, a tablet computer, a computer with a wires transceiver function, a virtual reality (VR) terminal device, an augmented reality (AR) terminal device, a wireless terminal for industrial control, a vehicle-mounted terminal device, a wireless terminal for self driving, a wireless terminal for remote medical, a wireless terminal device in a smart grid, a wireless terminal device for transportation safety, a wireless terminal device in a smart city, a wireless terminal device in smart home, a wearable terminal device, or the like. The terminal device in the embodiments of the present disclosure may also be referred to as terminal, user equipment (UE), access terminal device, vehicle-mounted terminal, industrial control terminal, UE unit, UE station, mobile station, mobile platform, remote station, remote terminal device, mobile device, UE terminal device, wireless communication device, UE proxy or UE apparatus, or the like. The terminal may be fixed or movable.

In the related technology, post-processing images refers to fine-tuning and optimizing generated images including, for example, adding filters to images, whitening images, slimming faces in images, and the like. Nowadays, when post-processing an image, the terminal device needs to create a temporary rendering texture for each post-processing operation, and then performs the post-processing on the image. For example, when performing whitening, filtering and beautification processing on an image, the terminal device needs to create at least one rendering texture for whitening, at least one rendering texture for filtering, and at least one rendering texture for beatification. In the case, the rendering textures occupy a large amount of memory, resulting in a waste of resources and a low efficiency of image post-processing.

The embodiments of the present disclosure provide an image processing method and apparatus, and a terminal device, to solve the technical problem existing in the prior art.

In order to solve the technical problem in the related technology, the embodiments of the present disclosure provide an image processing method. In response to post-processing for a first image, a terminal device can determine first texture information of rendering textures required for post-processing, and a first number of rendering textures associated with the first text information, and determine a first rendering texture based on the first texture information, the first number, and the texture pool; the terminal device can copy the first image to the first rendering texture, to obtain a second rendering texture, and perform the post-processing on the second rendering texture; and the terminal device can store the first or the second rendering texture in the texture pool. In this way, the terminal device can obtain quickly and accurately a first rendering texture from a texture pool based on the first texture information and the first number, thereby improving the efficiency and accuracy of image post-processing. Further, after using the first rendering texture, the terminal device can re-store the first or second rendering texture in the texture pool, and therefore can reuse the rendering textures required for post-processing based on the texture pool, without creating too many rendering textures, thereby reducing the memory occupied by the rendering textures and saving resources.

Embodiments of the present disclosure provide an image processing method and apparatus, and a terminal device. In response to post-processing for a first image, the terminal device determines a first rendering texture based on the post-processing and a texture pool, wherein the texture pool is used for storing a plurality of rendering textures required by the post-processing; the terminal device copies the first image to the first rendering texture, to obtain a second rendering texture; and the terminal device performs the post-processing on the second rendering texture, and stores the first or the second rendering texture in the texture pool. In the above method, the terminal device can obtain a first rendering texture from a texture pool, thereby improving the efficiency of image post-processing. Further, after using the first rendering texture, the terminal device can re-store the first or second rendering texture in the texture pool; therefore, the terminal device can reuse the rendering textures required for post-processing based on the texture pool, without creating too many rendering textures, thereby reducing the memory occupied by the rendering textures and saving resources.

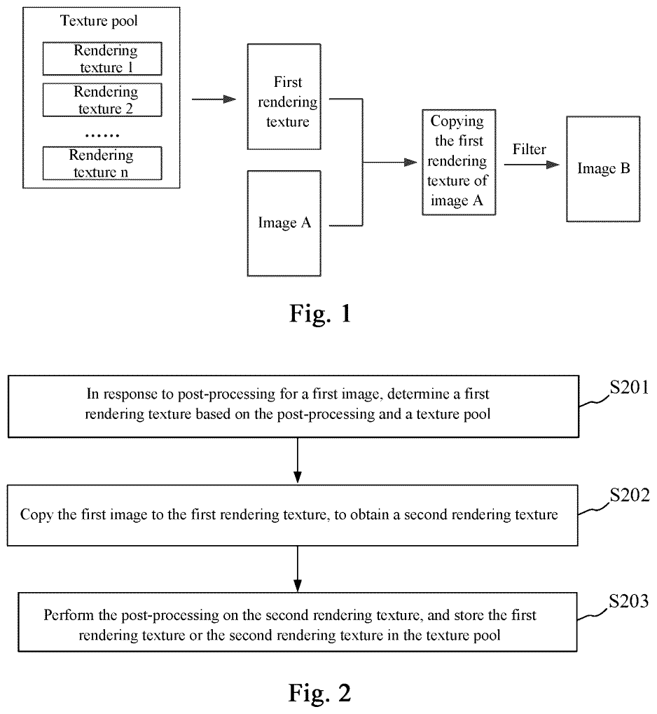

Reference below will be made to FIG. 1 to describe the application scenario of the embodiments of the present disclosure.

FIG. 1 is a schematic diagram of an application scenario provided by embodiments of the present disclosure, which includes a texture pool and an image A. Wherein, the texture pool includes a rendering texture 1, a rendering texture 2 ... a rendering texture n. The terminal device (not shown in FIG. 1) can obtain a first rendering texture from the texture pool based on post-processing (filters), and copy the image A to the first rendering texture, to obtain the first rendering texture with the copied image A. The terminal device can add a filter to the first rendering texture with the copied image A, to obtain an image B. Wherein, the image B may be an image obtained after the filter has been added to the image A. In this way, the terminal device can reuse the rendering texture based on the texture pool, without creating redundant rendering textures, thereby reducing the memory occupied by the rendering textures and saving resources. Moreover, the terminal device can obtain quickly the first rendering texture for post-processing from the texture pool, to improve the efficiency of image post-processing.

It is worth noting that FIG. 1 is an example of the application scenario in the embodiments of the present disclosure, not limiting the application scenario according to the embodiments of the present disclosure.

Hereinafter, details of specific embodiments will be provided to describe the technical solution of the present disclosure as well as how the technical solution of the present disclosure can solve the above-mentioned technical problem. Some specific embodiments can be combined, and details of the same or similar concepts or processes will be omitted in some embodiments. Reference below will be made to the drawings to detail the embodiments of the present disclosure.

FIG. 2 is a flowchart of an image processing method provided by embodiments of the present disclosure. As shown therein, the method may include:
S201: in response to post-processing for a first image, determining a first rendering texture based on the post-processing and a texture pool.

The performer of the embodiments of the present disclosure may be a terminal, or an image processing apparatus in the terminal device. Wherein, the image processing apparatus may be implemented based on software, or may be implemented based on a combination of hardware and software, which is not limited in the embodiments of the present disclosure.

Optionally, the post-processing for the first image may include adding a filter to the first image, whitening the first image, beautifying the first image, or any other post-processing, which is not limited herein.

The terminal device can obtain the post-processing for the first image in such a feasible way of: displaying a page including a control corresponding to at least one type of post-processing, and in response to a touch on the post-processing control, obtaining the post-processing for the first image.

The control corresponding to the post-processing can be associated with the post-processing. For example, if a user clicks a control corresponding to post-processing 1, post-processing obtained by the terminal device is the post-processing 1, and if the user clicks a control corresponding to post-processing 2, post-processing obtained by the terminal device is the post-processing 2. For example, after the user has clicked the control of the post-processing, the terminal device can respond to the post-processing for the first image.

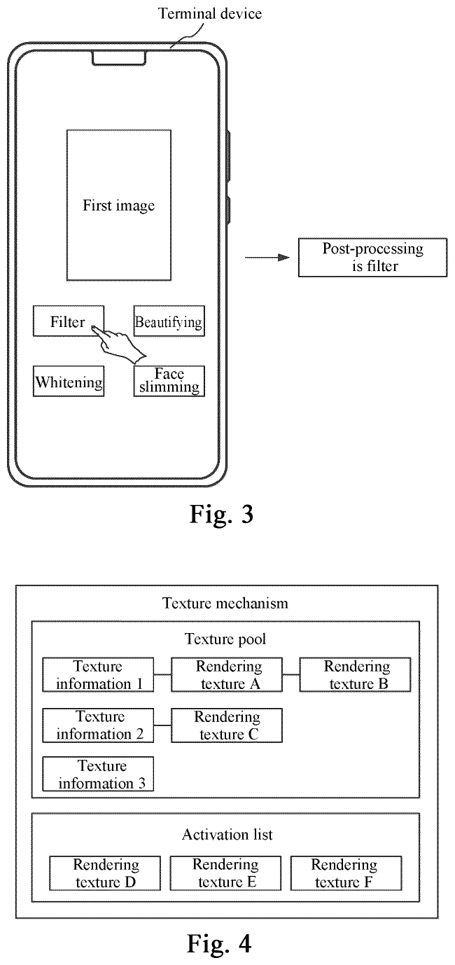

Reference now will be made to FIG. 3 to describe the process where the terminal device determines the post-processing for the first image.

FIG. 3 is a schematic diagram of a process of determining post-processing for a first image provided by the embodiments of the present disclosure, wherein a terminal device is included. Wherein, the page displayed by the terminal device includes a first image, a filter control, a beautify control, a whiten control, and a face slim control. If the user clicks the filter control, the terminal device can determine that the post-processing for the first image is adding a filter.

Optionally, in the embodiment shown in FIG. 3, if the user clicks the beautify control, the terminal device can determine that the post-processing for the first image is beautifying. If the user clicks the whiten control, the terminal device can determine that the post-processing for the first image is whitening. If the user clicks the face slim control, the terminal device can determine that the post-processing for the first image is face slimming. In this way, the terminal device can accurately determine the post-processing for the first image based on the user operation, thereby enhancing the accuracy in determining post-processing, and improving the user experience.

The first image may be an image in a video. For example, the video may include 100 frames of images, and when post-processing the video, the terminal device can perform post-processing on each frame of image in the video. For example, the terminal device can obtain a first image from the video to be post-processed, and the first image may be a first frame of image, a second frame of image ... or the last frame of image in the video to be post-processed, which is not limited herein.

The texture pool can be used to store a plurality of rendering textures required for the post-processing. The rendering textures can be used to carry an image content. For example, the rendering texture may be a “canvas,” a content of the “canvas” may be blank, and the terminal device can copy the image content to the “canvas.” For example, the texture pool can store a plurality of rendering textures, and the plurality of rendering textures may be rendering textures having been used in the post-processing. For instance, the terminal device can perform beautification processing and whitening processing on the video. The terminal device can perform the beautification processing and the whitening processing on the first frame of image in the video based on a rendering texture 1 and a rendering texture 2. In the case, when the terminal device performs the beautification processing and the whitening processing on the second frame of image in the video, the texture pool may include the rendering texture 1 and the rendering texture 2.

Optionally, the texture pool may be empty, or may include at least one rendering texture. For instance, when the terminal device performs post-processing on the first frame of image in the video, the texture pool may be empty, i.e., the texture pool does not include any rendering texture, and after the terminal device has performed multiple post-processing operations on a plurality of frames of images in the video, the texture pool may store the rendering textures having been used in the multiple post-processing operations.

Optionally, the texture pool may include rendering textures, and texture information of the rendering textures. Wherein, the texture information may be parameters of the rendering texture. For example, the texture information may be a length, a width, a height, a number of color bits, and the like, of the rendering texture, which is not limited herein.

Optionally, the texture pool can store rendering textures based on rendering information. For example, the texture pool may store rendering textures with the same texture information at locations associated with the texture information. For instance, the texture pool includes a memory space corresponding to texture information 1 (e.g. a memory space allocated by terminal device for the texture information 1) and a memory space corresponding to the texture information 2, and the terminal device can store the rendering texture with the texture information 1 into the memory space corresponding to the texture information 1, and store the rendering texture with the texture information 2 into the memory space corresponding to the texture information 2. For example, the texture information of the rendering texture A and the rendering texture B is the texture information 1, and the texture information of the rendering texture C is the texture information 2; the memory space corresponding to the texture information 1 is the memory space a, and the memory space corresponding to the texture information 2 is the memory space b; and the terminal device can store the rendering texture A and the rendering texture B into the memory space a, and store the rendering texture C into the memory space b.

Reference now will be made to FIG. 4 to describe a texture mechanism according to embodiments of the present disclosure.

FIG. 4 is a schematic diagram of a texture mechanism provided by embodiments of the present disclosure, wherein a texture mechanism is included. The texture mechanism includes a texture pool and an activation list. The texture pool may include texture information 1, texture information 2 and texture information 3. The rendering textures associated with the texture information 1 include the rendering texture A and the rendering texture B. The rendering texture associated with the texture information 2 includes the rendering texture C. The rendering texture associated with the texture information 3 is empty.

As shown in FIG. 4, the activation list may include a rendering texture D, a rendering texture E and a rendering texture F. The rendering texture D, the rendering texture E and the rendering texture F can be used in the image post-processing operation. At the end of the image post-processing operation, the terminal device (not shown in FIG. 4) can re-store the rendering texture D, the rendering texture E and the rendering texture F in the activation list into the texture pool (based on the texture information corresponding to the rendering textures).

The first rendering texture may be a texture required for post-processing for the first image. For example, if the terminal device responds to whitening processing for the first image, the first rendering texture may be a texture required for whitening, or if the terminal device responds to beautification processing for the first image, the first rendering texture may be a texture required for beautifying.

The terminal device can determine the first rendering texture in such a feasible way of: determining a first rendering texture; determining first rendering information of the first rendering texture required for the post-processing, and a first number of rendering textures associated with the first texture information; and determining a first rendering texture based on the first texture information, the first number, and the texture pool. As such, the terminal device can accurately determine the first rendering texture required for the post-processing, thereby improving the accuracy of the first rendering texture.

The first texture information may be texture information of the first rendering texture required for the post-processing. For instance, if the image has a size of 10*10, the first texture information of the first rendering texture required for the post-processing may include that the rendering texture have a length of 10 and a width of 10.

Optionally, the terminal device can determine the size of the first rendering texture required for the post-processing based on the size of the image, and can pre-set texture information (e.g. a number of color bits, and the like) corresponding to each post-processing operation.

Optionally, the terminal device can receive a post-processing request message for the first image which may include first texture information of at least one rendering texture required for the post-processing, and a first number of rendering textures corresponding to each first texture information. For instance, the terminal device can receive a whitening request message for the first image that may indicate first texture information containing a length of 10 and a width of 10, and first texture information containing a length of 20 and a width of 20 (i.e., 2 types of rendering textures are required for the whitening processing), and the whitening request message may indicate a first number of rendering textures corresponding to the first texture information containing a length of 10 and a width of 10, and a first number of rendering textures corresponding to the first texture information containing a length of 20 and a width of 10. For example, if the first number of the rendering textures corresponding to the first texture information containing a length of 10 and a width of 10 while the first number of the rendering textures corresponding to the first texture information containing a length of 20 and a width of 20, it is indicated that a rendering texture with a length of 10 and a width of 10, and 2 rendering textures each with a length of 20 and a width of 20 are required in this post-processing operation.
S202: copying the first image to the first rendering texture, to obtain a second rendering texture.

Wherein, the second rendering texture may include a first image content of the first image.

The terminal device can copy the image to the first rendering texture in such a feasible way of: obtaining a first image content of the first image; in response to the first rendering texture not including an image content, copying the first image content to the first rendering texture; in response to the first rendering texture including an image content, overwriting the image content in the first rendering texture with the first image content. Accordingly, the terminal device can accurately copy the first image to the first rendering texture, thus improving the accuracy of post-processing the first image.

Optionally, the first image content may be an object in the first image. For example, if the object in the first image is a triangular image, the first image content may be the triangular image; if the object in the first image is a circular image, the first image content may be the circular image.

Optionally, the first image content may be all the contents in the first image, which is not limited herein.

The first rendering texture may, or may not, include an image content. For instance, in response to the first rendering texture having been used in the previous post-processing process, the first rendering texture may include the image content copied in the previous post-processing processing. For example, if the terminal device has not used a first rendering process in the previous post-processing process, or the terminal device has deleted the image content copied to the first rendering texture after using the first rendering texture, the first rendering texture does not include an image content.

In response to the first rendering texture not including an image content, the terminal device can directly copy the first image content to the first rendering texture, to obtain a second rendering texture. For example, if the first image includes a triangular image, the terminal device can directly copy the triangular image into the first rendering texture, to obtain a second rendering texture, or the terminal device can directly copy the first image into the first rendering texture, to obtain a second rendering texture, which is not limited herein.

In response to the first rendering texture including an image content, the terminal device can overwrite the image content with the first image content. For example, if the first image includes a triangular image and the first rendering texture includes a circular image, the terminal device can delete the circular image in the first rendering texture while copying the triangular image into the first rendering image, to obtain a second rendering image, or the terminal determine can replace the circular image in the first rendering texture with the triangular image, to obtain a second rendering image, which is not limited herein.

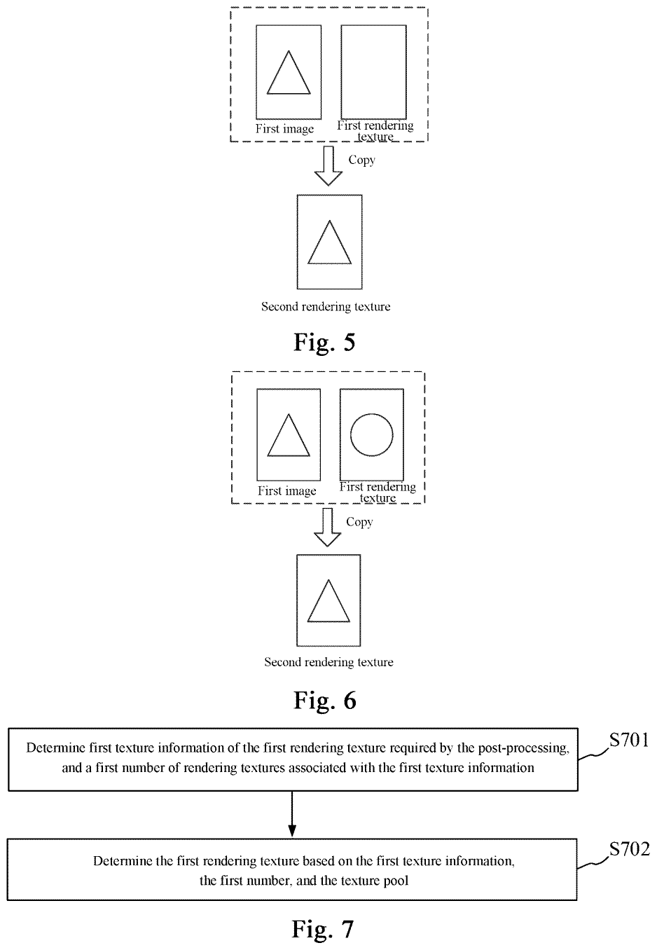

Hereinafter, reference will be made to FIGS. 5-6 to describe a process of determining a second rendering texture.

FIG. 5 is a schematic diagram of a method of determining a second rendering texture provided by embodiments of the present disclosure, wherein a first image and a first rendering texture are included. Wherein, the first image content of the first image is a triangular image, and the first rendering texture does not include a second image content. The terminal device (not shown in FIG. 5) can copy the triangular image into the first rendering texture, to obtain a second rendering texture. In the case, the second rendering texture may include the triangular image.

FIG. 6 is a schematic diagram of a further method of determining a second rendering texture provided by embodiments of the present disclosure, wherein a first image and a first rendering texture are included. Wherein, the first image content of the first image is a triangular image, and the image content of the first rendering texture is a circular image. The terminal device (not shown in FIG. 6) can replace the circular image in the first rendering texture with the triangular image in the image, to obtain a second rendering image. In the case, the second rendering texture may include the triangular image.
S203: performing the post-processing on the second rendering texture, and storing the first or the second rendering texture in the texture pool.

The terminal device can perform the post-processing on the second rendering texture. For example, in the embodiment as shown FIG. 5, the second rendering texture may include a triangular image, and the terminal device can adjust the color of the triangular image of the second rendering texture.

It is worth noting that the terminal device can perform the post-processing on the second rendering texture in any feasible way, which is not limited herein.

At the end of the post-processing, the terminal device can re-store the first or the second rendering texture into the texture pool. For example, the first rendering texture and the second rendering texture have a different image content, but include the same texture information. Therefore, the first and the second rendering texture can be considered as the same rendering texture during use.

Optionally, the terminal device can directly store the second rendering texture into the texture pool, or can store the second rendering texture without the image content (the first rendering texture) into the texture tool, which is not limited herein. For example, when the terminal device performs whitening processing on the first image, the texture pool can add the rendering texture 1 and the rendering texture 2 into the activation list, and following the whitening processing on the first image, the terminal device can re-store the rendering texture 1 and the rendering texture 2 in the activation list into the texture pool, or can re-store the rendering texture 1 and the rendering texture 2 without the image contents into the texture pool.

Optionally, the terminal device can store the second rendering texture in the memory space for storing the texture information corresponding to the second rendering texture. For example, in the embodiment as shown in FIG. 4, if the terminal device adds the rendering texture D of the texture information 3 into the activation list, at the end of using the rendering texture D (the texture information D may include an image content, but the texture information is kept unchanged), the terminal device can re-store the rendering texture D into the memory space corresponding to the texture information 3.

Optionally, after the terminal device stores the second rendering texture into the texture pool, the image processing method further includes: copying a second image content in the second rendering texture into an output texture, to obtain a second image; and rendering and displaying the second image.

The output texture can be used for rendering or displaying. For example, in the image post-processing process, one or more rendering textures (also referred to as temporary texture) can be created, which can store and process image data (e.g. shadow mapping, reflection mapping, or the like), and after the processing has been completed, the one or more rendering textures can be combined or copied into the output texture for display on the screen.

The second image may be an image obtained after post-processing the first image. For instance, if the first image is subjected to whitening processing, the second image is an image obtained after performing the whitening processing on the first image; or if the first image is subjected to beautification processing, the second image is an image obtained after performing the beautification processing on the first image.

The method for the terminal device to copy the second image content in the second rendering texture to the output texture is identical to the method for the terminal device to copy the first image to the first rendering texture, details of which will be omitted herein.

After obtaining the second image, the terminal device can render and display the second image on the screen, such that the user can browse promptly the effect of the post-processed first image, improving the user experience.

The embodiments of the present disclosure provide an image processing method. In response to post-processing for a first image, a terminal device can determine first texture information of rendering textures required for the post-processing, and a first number of rendering textures associated with the first text information, and can determine a first rendering texture based on the first texture information, the first number and a texture pool; the terminal device can copy the first image to the first rendering texture, to obtain a second rendering texture, and perform post-processing on the second rendering texture; the terminal device can store the second rendering texture into the texture pool; and the terminal device can copy a second image content in the second rendering texture into an output texture, to obtain a second image, and then render and display the second image. In this way, the terminal device can obtain quickly and accurately a first rendering texture from a texture pool based on the first texture information and the first number, thereby improving the efficiency and accuracy of image post-processing. Further, after using the first rendering texture, the terminal device can re-store the second rendering texture (or the first rendering texture) in the texture pool, and therefore can reuse the rendering textures required for post-processing based on the texture pool, without creating too many rendering textures, thereby reducing the memory occupied by the rendering textures and saving resources. In addition, the terminal device can promptly display the post-processed second image, thereby enhancing the image display efficiency and improving the user experience.

On the basis of the embodiment as shown in FIG. 2, reference now will be made to FIG. 7 to detail the method of determining the first rendering texture based on the post-processing and the texture pool included in the image processing method as described above.

FIG. 7 is a schematic diagram of a method of determining a first rendering texture provided by embodiments of the present disclosure. As shown therein, the method includes:
S701: determining first texture information required for post-processing, and a first number of rendering textures associated with the first texture information.
S702, determining a first rendering texture based on the first texture information, the first number, and the texture tool.

The terminal device can determine the first rendering texture in such a feasible way of: determining whether the texture pool includes second texture information identical to the first texture information; in response to the texture pool including the second texture information, determining the first rendering texture based on the second texture information, the first number, and the texture tool; or in response to the texture pool not including the second texture information, creating a first number of the first rendering textures based on the first texture information. Therefore, the terminal device can reuse the first rendering texture in the texture pool, thereby saving resources.

The second texture information may be identical to the first texture information. For example, if the first texture information is that the rendering texture has a length of 10 and a width of 10, the second texture information may be that the rendering texture has a length of 10 and a width of 10; or if the first texture information is that the rendering texture has a length of 20 and a width of 20, the second texture information may be that the rendering texture has a length of 20 and a width of 20.

Optionally, the terminal device can determine whether the texture pool includes second texture information identical to first texture information in any feasible way, which is not limited herein.

If the texture pool includes second texture information identical to first texture information, it is indicated that the texture pool may include a first rendering texture, and the terminal device therefore can determine the first rendering texture based on the second texture information, the first number, and the texture pool.

If the texture pool does not include second texture information identical to first texture information, it is indicated that the texture pool does not include a first rendering texture, and the terminal device therefore can create a first number of first rendering textures based on the first texture information. For example, the first texture information includes that the rendering texture has a length of 10 and a width of 10, and the first number is 3; and if the texture pool does not include second texture information identical to first texture information, the terminal device can create 3 first rendering textures each having a length of 10 and a width of 10.

The terminal device determines a first rendering texture based on the second texture information, the first number, and the texture tool, specifically including: determining whether the texture tool includes a first rendering texture based on the second texture information, and determining a first rendering texture based on the result.

If the texture pool includes a rendering texture corresponding to the second texture information, the terminal device can determine that the texture pool includes a first rendering texture. For example, since the first texture information is identical to the second texture information, the rendering texture may be the first rendering texture if the texture information of the rendering texture in the texture pool is the second texture information. For instance, the texture pool includes a rendering texture 1 and a rendering texture 2, wherein the rendering texture 1 has a size of 10*10, and the rendering texture 2 has a size of 20*20; if the second texture information is that the rendering texture has a length of 10 and a width of 10, the terminal device can determine that the texture pool includes a first rendering texture, and determine the rendering texture 1 as the first rendering texture.

It is worth noting that the terminal device can determine whether the texture pool includes a first rendering texture in any feasible way, which is not limited herein.

There are following three cases for determining, by the terminal device, the first rendering texture based on the result (the result indicating whether the texture pool includes a first rendering texture):

Case 1: the texture pool includes first rendering textures, and a second number of the first rendering textures in the texture pool is greater than or equal to the first number.

If the texture pool includes first rendering textures, and a second number of the first rendering textures in the texture pool is greater than or equal to the first number, the terminal device can obtain the first number of first rendering textures from the texture pool. For example, if the texture pool includes first rendering textures, and a second number of the first rendering textures is greater than or equal to the first number, it is indicated that the terminal device can obtain sufficient first rendering textures from the texture pool, without creating first rendering textures. For instance, the texture pool includes 4 first rendering textures, if 3 first rendering textures are required for the terminal device to perform the post-processing on the first image, the terminal device can obtain 3 first rendering textures from the texture pool.

Case 2: the texture pool includes first rendering textures, and a second number of the first rendering textures in the texture pool is less than the first number.

If the texture pool includes first rendering textures, and a second number of the first rendering textures in the texture pool is less than the first number, the terminal device can obtain a second number of the first rendering textures from the texture pool, and create a third number of the first rendering textures based on the second texture information.

The third number is a difference between the first number and the second number. For example, if the first number is 3, and the second number is 2, the third number may be 1.

For instance, if the texture pool includes first rendering textures, and a second number of the first rendering textures is less than the first number, it is indicated that the terminal device cannot obtain sufficient first rendering textures from the texture pool, and the terminal device therefore needs to create some first rendering textures to perform the post-processing on the first image. For example, the texture pool includes 2 first rendering textures; if 3 first rendering textures are required for the terminal device to perform post-processing on the first image, the terminal device can obtain 2 first rendering textures from the texture pool; since the first texture information is identical to the second texture information, the terminal device can create at least one first rendering texture based on the second texture information, to thus obtain sufficient first rendering textures.

Case 3: the texture pool does not include any first rendering texture.

If the texture pool does not include any first rendering texture, the terminal device can create the first number of the first rendering textures based on the second texture information. For example, if the texture pool does not include any first rendering texture, it is indicated that the terminal device cannot obtain any first rendering texture from the texture pool; since the first texture information is identical to the second texture information, the terminal device can create the first number of the first rendering textures based on the second texture information. For instance, the texture pool does not include any first rendering texture; if 3 first rendering textures are required for the terminal device to perform post-processing on the first image, the terminal device can create at least 3 first rendering textures based on the second texture information, to thus obtain sufficient first rendering textures.

Optionally, in the above 3 cases, if the terminal device creates a first rendering texture, after the first rendering texture has been used, the terminal device can store the newly created first rendering texture in the texture pool (or copy the second rendering texture of the first image); in this way, the number of the first rendering textures in the texture pool can be increased gradually, and the first rendering textures that can be reused by the terminal device can also be increased gradually, which can increase the reuse rate of the first rendering textures, and improve the efficiency of post-processing the first image.

The embodiments of the present disclosure provide a method of determining a first rendering texture. The terminal device can determine first texture information of a first rendering texture required for post-processing, and a first number of rendering textures associated with the first texture information, and can determine whether the texture pool includes second texture information identical to the first texture information; in response to the texture pool including the second texture information, the terminal device can determine the first rendering texture based on the second texture information, the first number, and the texture tool; or in response to the texture pool not including the second texture information, the terminal device can create the first number of the first rendering textures based on the first texture information. In this way, the terminal device can accurately reuse the rendering texture in the texture pool, and the first rendering textures in the texture pool, which can be reused by the terminal device, can be increased, which can increase the reuse rate of the rendering textures, and improve the efficiency of post-processing the first image.

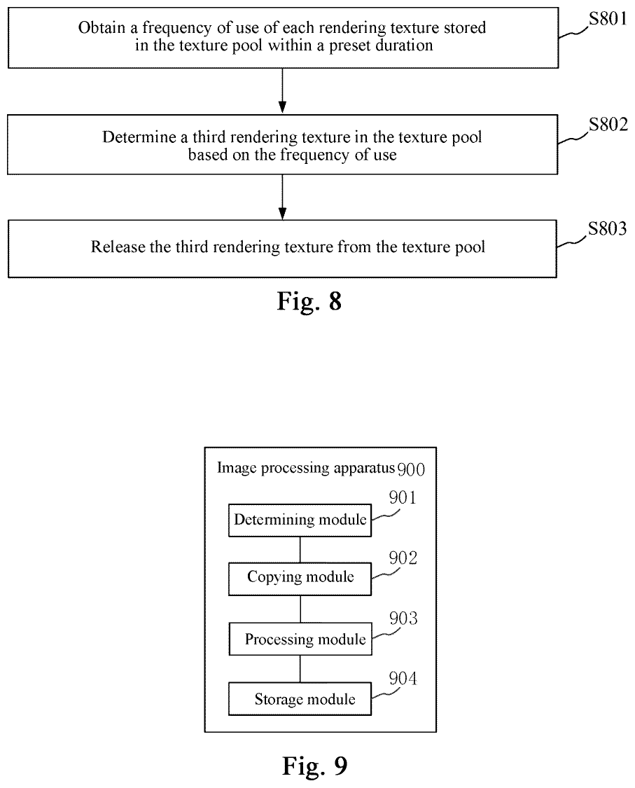

On the basis of any of the embodiments described above, after the terminal device has stored the second rendering textures in the texture pool, the method may further include a method of releasing a rendering texture in the texture pool. Hereinafter, reference will be made to FIG. 8 to describe the method of releasing a rendering texture in the texture pool.

FIG. 8 is a schematic diagram of a method of releasing a rendering method provided by embodiments of the present disclosure. As shown therein, the method includes:
S801: obtaining a frequency of use of each rendering texture stored in the texture pool within a preset duration.

Optionally, the preset duration may be a period of time, or may be a time for a terminal device to process a set of video frames, which is not limited herein. For example, the preset duration may be 1 second, 2 seconds, or the like, or the preset duration may be a time for a terminal device to process 10 image frames, 20 image frames, or the like.

The frequency of use may be a frequency of using the rendering texture within a preset duration. For instance, if the preset duration is 1 second, the frequency of use may be a number of times that each rendering texture in the texture pool is used within 1 second. For instance, if the preset duration is a time used by the terminal device to process 20 image frames, the frequency of use may be a number of times that each rendering texture in the texture pool is used when the terminal device processes 20 image frames.

For example, the texture pool may include a rendering texture 1 and a rendering texture 2; if the rendering texture 1 is used once and the rendering texture 2 is used twice within 1 second, the frequency of use of the rendering texture 1 is 1, and the frequency of use of the rendering texture 2 is 2.

For instance, the texture pool may include a rendering texture 1 and a rendering texture 2, if the rendering texture 1 is used 3 times and the rendering texture 2 is used 5 times in the process where the terminal device processes 20 frames of the first images, the frequency of use of the rendering texture 1 is 3, and the frequency of use of the rendering texture 2 is 5.

It is worth noting that the terminal device can determine the frequency of use of each rendering texture within a preset duration in any feasible way, which is not limited herein.
S802: determining a third rendering texture in the texture pool based on the frequency of use.

The frequency of use of the third rendering texture is less than or equal to a preset threshold. For example, if the frequency of use of the rendering texture in the texture pool is greater than a preset threshold, the rendering texture is not the third rendering texture; or if the frequency of use of the rendering texture in the texture pool is less than a preset threshold, the rendering texture is the third rendering texture. For instance, the texture pool may include a rendering texture 1, a rendering texture 2 and a rendering texture 3; if the respective frequencies of use of the rendering texture 1 and the rendering texture 2 are 2 and the frequency of use of the rendering texture 3 is 0, the terminal device can determine the rendering texture 3 as the third rendering texture.

Optionally, the preset threshold may be any numerical value such as 0, 1, 2 or the like, or any numerical value from 0 to 10, which is not limited herein.
S803: releasing the third rendering texture in the texture pool.

The terminal device can release the third rendering texture in the texture pool. Accordingly, if a frequency of use of a rendering texture in the texture pool is too low, the terminal device can release the rendering texture in the texture pool, thereby saving the memory of the texture pool.

The embodiments of the present disclosure provide a method of releasing a rendering texture, including: obtaining a frequency of use of each rendering texture stored in the texture pool within a preset duration; determining a third rendering texture with a frequency of use less than or equal to a preset threshold in the texture pool based on the frequency of use; and releasing the third rendering texture from the texture pool. In this way, the terminal device can release a rendering texture with a low frequency of use in the texture pool, which can prevent too many rendering textures from occupying the memory of the texture pool, and thus improve the utilization rate of the memory of the texture pool and save the resources.

FIG. 9 is a schematic diagram of a structure of an image processing apparatus provided by embodiments of the present disclosure. As shown therein, the image processing apparatus 900 includes a determining module 901, a copying module 902, a processing module 903, and a storage module 904, where:

The determining module 904 is used for, in response to post-processing for a first image, determining a first rendering texture based on the post-processing and a texture pool used for storing a plurality of rendering textures required by the post-processing;

The copying module 902 is used for copying the first image to the first rendering texture, to obtain a second rendering texture;

The processing module 903 is used for performing the post-processing on the second rendering texture, and

The storage module 904 is used for storing the first rendering texture or the second rendering texture in the texture pool.

According to one or more embodiments of the present disclosure, the determining module 901 is specifically used for:
determining first texture information of the first rendering texture required by the post-processing, and a first number of rendering textures associated with the first texture information; and
determining the first rendering texture based on the first texture information, the first number, and the texture pool.

According to one or more embodiments of the present disclosure, the determining module 901 is specifically used for:
determining whether the texture pool comprises second texture information identical to the first texture information;
in response to the texture pool comprising the second texture information, determining the first rendering texture based on the second texture information, the first number, and the texture tool; or
in response to the texture pool not comprising the second texture information, creating the first number of the first rendering textures based on the first texture information.

According to one or more embodiments of the present disclosure, the determining module 901 is specifically for:
determining whether the texture pool comprises the first rendering texture based on the second texture information;
in response to the texture pool comprising the first rendering texture, and a second number of the first rendering textures in the texture pool being greater than or equal to the first number, obtaining the first number of the first rendering textures in the texture pool;
in response to the texture pool comprising the first rendering texture, and the second number of the first rendering textures in the texture pool being less than the first number, obtaining the second number of the first rendering textures in the texture pool, and creating a third number of the first rendering textures based on the second texture information, wherein the third number is a difference between the first number and the second number; or
in response to the texture pool not comprising the first rendering texture, creating the first number of the first rendering textures based on the second texture information.

According to one or more embodiments of the present disclosure, the copying module 902 is specifically used for:
obtaining a first image content of the first image;
in response to the first rendering texture not comprising an image content, copying the first image content to the first rendering texture; or
in response to the first rendering texture comprising an image content, overwriting the image content in the first rendering texture with the first image content.

According to one or more embodiments of the present disclosure, the processing module 903 is further used for:
obtaining a frequency of use of each rendering texture stored in the texture pool within a preset duration;
determining a third rendering texture with a frequency of use less than or equal to a preset threshold in the texture pool based on the frequency of use; and
releasing the third rendering texture from the texture pool.

According to one or more embodiments, the processing module 903 is further used for:
copying a second image content in the second rendering texture to an output texture, to obtain a second image; and
rendering and displaying the second image.

The image processing apparatus provided by the embodiments of the present disclosure can be used to implement the technical solution according to the method embodiments described above. The implementation principle and technical effect thereof are similar, details of which are omitted herein.

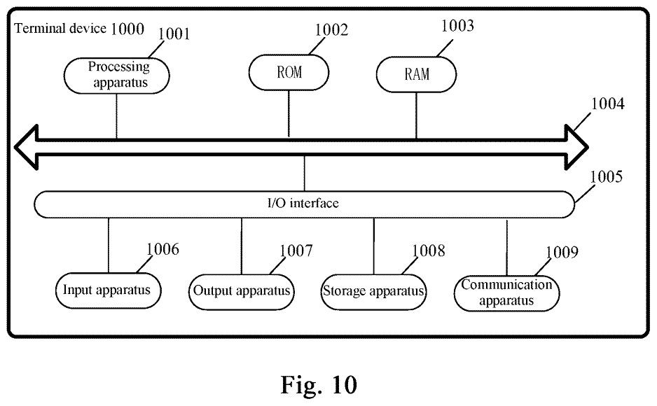

FIG. 10 illustrates a schematic diagram of a structure of a terminal device provided by embodiments of the present disclosure. Hereinafter, reference will be made to FIG. 10 that illustrates a schematic diagram of a structure of an electronic device 1000 adapted to implement embodiments of the present disclosure. The terminal device according to the embodiments of the present disclosure may include a mobile terminal such as a mobile phone, a laptop computer, a digital broadcast receiver, a Personal Digital Assistant (PDA), a Portable Android Device (PAD), a Portable Media Player (PMP), an on-vehicle terminal (e.g. an on-vehicle navigation terminal) or the like, or a fixed terminal such as a digital television (TV), a desktop computer or the like. The terminal device as shown in FIG. 10 is provided merely as an example, without suggesting any limitation to the functions and the application range of the embodiments of the present disclosure.

As shown therein, the terminal device 1000 may include a processor (e.g. a central processor, a graphics processor or the like) 1001, which can execute various acts and processing based on programs stored in a Read Only Memory (ROM) 1002 or a program loaded from a storage apparatus 1008 to a Random Access Memory (RAM) 1003. RAM 1003 stores therein various programs and data required for operations of the electronic device 1000. The processor 1001, the ROM 1002 and the RAM 1003 are connected to one another via a bus 1004. An input/output (I/O) interface 1005 is also connected to the bus 1004.

Typically, the following apparatuses may be connected to the I/O interface 1005: an input apparatus 1006 including, for example, a touchscreen, a touch pad, a keyboard, a mouse, a camera, a microphone, an accelerometer, a gyroscope and the like; an output apparatus 1007 including, for example, a Liquid Crystal Display (LCD), a loudspeaker, a vibrator and the like; a storage apparatus 1008 including, for example, a tape, a hard drive and the like; and a communication apparatus 1009. The communication apparatus 1009 can allow wireless or wired communication of the terminal device 1000 with other devices to exchange data. Although FIG. 10 shows the terminal device 1000 including various apparatuses, it would be appreciated that not all of the apparatuses as shown are required to be implemented or provided. Alternatively, more or fewer apparatuses may be implemented or provided.

In particular, according to embodiments of the present disclosure, the processes described above with reference to the flowchart may be implemented as a computer software program. For example, embodiments of the present disclosure include a computer program product comprising computer programs carried on a non-transitory computer readable medium, the computer program containing program code for performing the method as shown in the flowchart. In those embodiments, the computer program may be downloaded and installed from a network via the communication apparatus 1009, or may be installed from the storage apparatus 1008, or may be installed from the ROM 1002. The computer program, when executed by the processor 1001, performs the above-described functions defined in the method according to the embodiments of the present disclosure.

The computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, an RAM, an ROM, an Erasable Programmable Read-Only Memory (EPROM or flash memory), an optical fiber, a portable Compact Disc Read-Only Memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

The computer-readable medium may be the one included in the electronic device, or may be provided separately, rather than assembled in the electronic device.

The computer-readable medium carries one or more programs which, when executed by the terminal device, cause the terminal device to: perform the method according to the above embodiments.

The embodiments of the present disclosure provide a computer-readable storage medium having computer-executable instructions stored thereon, wherein various possible methods involved in the above embodiments can be implemented when the processor executes the computer-executable instructions.

The embodiments of the present disclosure provide a computer program product comprising a computer program that, when executed by a processor, implements various possible methods involved in the above embodiments.

Computer program code for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program code may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowchart and block diagrams in the drawings illustrate the architecture, functionality and operation of possible implementations of systems, methods and computer program products according to various embodiments of the present disclosure. In this regard, each block in the flowchart or block diagrams may represent a block, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

Related units for describing the embodiments of the present disclosure may be implemented in the form of software, or may be implemented in the form of hardware. In certain circumstances, the names of units/blocks do not formulate limitation to the unit per se. For example, the first obtaining apparatus may be described as “a unit for obtaining at least two Internet Protocol Addresses.”

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, an RAM, an ROM, an EPROM or flash memory, an optical fiber, a CD-ROM, an optical storage device, a magnetic storage device, or any suitable combination of the foregoing.

It should be noted that, the terms “one” and “a plurality of” mentioned in the present disclosure are illustrative, not restrictive, and should be understood as “one or more” by those skilled in the art, unless explicitly specified otherwise in the context.

Names of messages or information interacted between a plurality of apparatuses in the embodiments of the present disclosure are illustrative, rather than limit the scope of the messages or information.

The data (including data per se, and acquisition or application of the data) involved in the present technical solution should comply with the provisions of the corresponding laws and regulations as well as relevant stipulations. The data may include information, parameters, messages, and the like, for example, flow switching instruction information.

Above described are only optimal embodiments of the present disclosure and the technical principles applied therein. It would be appreciated by those skilled in the art that the scope of the disclosure herein is not limited to the particular combination of features described above, but also encompasses other embodiments in which any combination of the features described above or their equivalents does not depart from the spirit of the disclosure. For example, the above features and (but not limited to) the features disclosed in this disclosure having similar functions are replaced with each other to form the technical solution.

Further, while operations are depicted in a particular order, this should not be understood as requiring that such operations be performed in the particular order shown or in sequential order. In certain circumstances, multitasking and parallel processing may be advantageous. Likewise, while several specific implementation details are contained in the above discussions, these should not be construed as limitations on the scope of the present disclosure, but rather as descriptions of features that may be specific to particular implementations. Certain features that are described in the context of separate embodiments may also be implemented in combination in a single embodiment. Conversely, various features that are described in the context of a single embodiment may also be implemented in multiple embodiments separately or in any suitable sub-combination. Although the present disclosure has been described in language specific to structural features and/or methodological acts, it is to be understood that the present disclosure specified in the appended claims is not necessarily limited to the specific features or acts described above. Rather, the specific features and acts described above are disclosed as example forms of implementing the claims.

I/We claim:

1. An image processing method, comprising:
in response to post-processing for a first image, determining a first rendering texture based on the post-processing and a texture pool used for storing a plurality of rendering textures required by the post-processing;
copying the first image to the first rendering texture, to obtain a second rendering texture; and
performing the post-processing on the second rendering texture, and storing the first rendering texture or the second rendering texture in the texture pool.

2. The method of claim 1, wherein determining the first rendering texture based on the post-processing and the texture pool comprises:
determining first texture information of the first rendering texture required by the post-processing, and a first number of rendering textures associated with the first texture information; and
determining the first rendering texture based on the first texture information, the first number, and the texture pool.

3. The method of claim 2, wherein determining the first rendering texture based on the first texture information, the first number, and the texture pool comprises:
determining whether the texture pool comprises second texture information identical to the first texture information;
in response to the texture pool comprising the second texture information, determining the first rendering texture based on the second texture information, the first number, and the texture tool; or
in response to the texture pool not comprising the second texture information, creating the first number of the first rendering textures based on the first texture information.

4. The method of claim 3, wherein determining the first rendering texture based on the second texture information, the first number, and the texture pool comprises:
determining whether the texture pool comprises the first rendering texture based on the second texture information;
in response to the texture pool comprising the first rendering texture, and a second number of the first rendering textures in the texture pool being greater than or equal to the first number, obtaining the first number of the first rendering textures in the texture pool;
in response to the texture pool comprising the first rendering texture, and the second number of the first rendering textures in the texture pool being less than the first number, obtaining the second number of the first rendering textures in the texture pool, and creating a third number of the first rendering textures based on the second texture information, wherein the third number is a difference between the first number and the second number; or
in response to the texture pool not comprising the first rendering texture, creating the first number of the first rendering textures based on the second texture information.

5. The method of claim 1, wherein copying the first image to the first rendering texture comprises:
obtaining a first image content of the first image;
in response to the first rendering texture not comprising an image content, copying the first image content to the first rendering texture; or
in response to the first rendering texture comprising an image content, overwriting the image content in the first rendering texture with the first image content.

6. The method of claim 1, wherein, after storing the second rendering texture in the texture pool, the method further comprises:
obtaining a frequency of use of each rendering texture stored in the texture pool within a preset duration;
determining a third rendering texture with a frequency of use less than or equal to a preset threshold in the texture pool based on the frequency of use; and
releasing the third rendering texture from the texture pool.

7. The method of claim 1, wherein, after storing the second rendering texture in the texture pool, the method further comprises:
copying a second image content in the second rendering texture to an output texture, to obtain a second image; and
rendering and displaying the second image.

8. A terminal device, comprising: a processor and a memory, wherein:
the memory stores computer executable instructions; and
the processor executes the computer executable instructions stored in the memory, to cause the processor to perform an image processing method comprising:
in response to post-processing for a first image, determining a first rendering texture based on the post-processing and a texture pool used for storing a plurality of rendering textures required by the post-processing;
copying the first image to the first rendering texture, to obtain a second rendering texture; and
performing the post-processing on the second rendering texture, and storing the first rendering texture or the second rendering texture in the texture pool.

9. The terminal device of claim 8, wherein determining the first rendering texture based on the post-processing and the texture pool comprises:
determining first texture information of the first rendering texture required by the post-processing, and a first number of rendering textures associated with the first texture information; and
determining the first rendering texture based on the first texture information, the first number, and the texture pool.

10. The terminal device of claim 9, wherein determining the first rendering texture based on the first texture information, the first number, and the texture pool comprises:
determining whether the texture pool comprises second texture information identical to the first texture information;
in response to the texture pool comprising the second texture information, determining the first rendering texture based on the second texture information, the first number, and the texture tool; or
in response to the texture pool not comprising the second texture information, creating the first number of the first rendering textures based on the first texture information.

11. The terminal device of claim 10, wherein determining the first rendering texture based on the second texture information, the first number, and the texture pool comprises:
determining whether the texture pool comprises the first rendering texture based on the second texture information;
in response to the texture pool comprising the first rendering texture, and a second number of the first rendering textures in the texture pool being greater than or equal to the first number, obtaining the first number of the first rendering textures in the texture pool;
in response to the texture pool comprising the first rendering texture, and the second number of the first rendering textures in the texture pool being less than the first number, obtaining the second number of the first rendering textures in the texture pool, and creating a third number of the first rendering textures based on the second texture information, wherein the third number is a difference between the first number and the second number; or
in response to the texture pool not comprising the first rendering texture, creating the first number of the first rendering textures based on the second texture information.

12. The terminal device of claim 8, wherein copying the first image to the first rendering texture comprises:
obtaining a first image content of the first image;
in response to the first rendering texture not comprising an image content, copying the first image content to the first rendering texture; or
in response to the first rendering texture comprising an image content, overwriting the image content in the first rendering texture with the first image content.

13. The terminal device of claim 8, wherein, after storing the second rendering texture in the texture pool, the method further comprises:
obtaining a frequency of use of each rendering texture stored in the texture pool within a preset duration;
determining a third rendering texture with a frequency of use less than or equal to a preset threshold in the texture pool based on the frequency of use; and
releasing the third rendering texture from the texture pool.

14. The terminal device of claim 8, wherein, after storing the second rendering texture in the texture pool, the method further comprises:
copying a second image content in the second rendering texture to an output texture, to obtain a second image; and
rendering and displaying the second image.

15. A non-transitory computer-readable storage medium, wherein the computer-readable storage medium stores therein computer-executable instructions which, when executed by a processor, cause the processor to implement an image processing method comprising:
in response to post-processing for a first image, determining a first rendering texture based on the post-processing and a texture pool used for storing a plurality of rendering textures required by the post-processing;
copying the first image to the first rendering texture, to obtain a second rendering texture; and
performing the post-processing on the second rendering texture, and storing the first rendering texture or the second rendering texture in the texture pool.

16. The non-transitory computer-readable storage medium of claim 15, wherein determining the first rendering texture based on the post-processing and the texture pool comprises:
determining first texture information of the first rendering texture required by the post-processing, and a first number of rendering textures associated with the first texture information; and
determining the first rendering texture based on the first texture information, the first number, and the texture pool.

17. The non-transitory computer-readable storage medium of claim 16, wherein determining the first rendering texture based on the first texture information, the first number, and the texture pool comprises:
determining whether the texture pool comprises second texture information identical to the first texture information;
in response to the texture pool comprising the second texture information, determining the first rendering texture based on the second texture information, the first number, and the texture tool; or
in response to the texture pool not comprising the second texture information, creating the first number of the first rendering textures based on the first texture information.

18. The non-transitory computer-readable storage medium of claim 17, wherein determining the first rendering texture based on the second texture information, the first number, and the texture pool comprises:
determining whether the texture pool comprises the first rendering texture based on the second texture information;
in response to the texture pool comprising the first rendering texture, and a second number of the first rendering textures in the texture pool being greater than or equal to the first number, obtaining the first number of the first rendering textures in the texture pool;
in response to the texture pool comprising the first rendering texture, and the second number of the first rendering textures in the texture pool being less than the first number, obtaining the second number of the first rendering textures in the texture pool, and creating a third number of the first rendering textures based on the second texture information, wherein the third number is a difference between the first number and the second number; or
in response to the texture pool not comprising the first rendering texture, creating the first number of the first rendering textures based on the second texture information.

19. The non-transitory computer-readable storage medium of claim 15, wherein copying the first image to the first rendering texture comprises:
obtaining a first image content of the first image;
in response to the first rendering texture not comprising an image content, copying the first image content to the first rendering texture; or
in response to the first rendering texture comprising an image content, overwriting the image content in the first rendering texture with the first image content.

20. The non-transitory computer-readable storage medium of claim 15, wherein, after storing the second rendering texture in the texture pool, the method further comprises:
obtaining a frequency of use of each rendering texture stored in the texture pool within a preset duration;
determining a third rendering texture with a frequency of use less than or equal to a preset threshold in the texture pool based on the frequency of use; and
releasing the third rendering texture from the texture pool.
